(19) United States
(12) Patent Application Publication
(10) Pub. No.: US 2022/0118697 A1
(43) Pub. Date: Apr. 21, 2022

(54) MULTI-MATERIAL THREE-DIMENSIONAL PRINTER

(71) Applicant: Morningbird Media Corporation, Victoria, TX (US)

(72) Inventors: Chance M. GLENN, Victoria, TX (US); Wing CHAN, Victoria, TX (US); Corey B. MACK, Victoria, TX (US)

(73) Assignee: Morningbird Media Corporation, Victoria, TX (US)

(21) Appl. No.: 17/505,187

(22) Filed: Oct. 19, 2021

Related U.S. Application Data
(60) Provisional application No. 63/093,556, filed on Oct. 19, 2020.

(51) Int. Cl. B29C 64/209; B29C 64/25; B29C 64/245; B29C 64/118; B29C 64/255; B29C 64/236; B29C 64/232; B29C 64/336

(52) U.S. Cl. CPC B29C 64/209; B29C 64/25; B29C 64/245; B29C 64/118; B29K 2995/0021; B29C 64/236; B29C 64/232; B29C 64/336; B29C 64/255

(57) ABSTRACT

Disclosed are embodiments of a multi-material three-dimensional printer. Also disclosed are methods of three-dimensional printing multi-material objects, components and/or devices using the disclosed three-dimensional printer. Also disclosed are methods of three-dimensional printing multi-colored objects, components and/or devices using the disclosed three-dimensional printer. Additionally, filament compositions which can be used in three-dimensional printing, are disclosed, as well as methods of making the same.

### FIELD

The present disclosure relates to a multi-material three-dimensional printer. The present disclosure further relates to methods of three-dimensional printing, filament to be used in three-dimensional printing, and methods of making the same.

### BACKGROUND INFORMATION

3D printing is any of various processes in which a material is joined or solidified under computer control to create a three-dimensional object, with the material being added together (such as liquid molecules or powder grains being fused together). 3D printing can be used in both rapid prototyping and additive manufacturing. Objects typically are produced using digital model data from a 3D model or another electronic data source such as an Additive Manufacturing File (AMF).

Additive manufacturing is becoming a leading method for reducing costs, increasing quality, and shortening schedules for production of innovative parts and components that were previously not possible using more traditional methods of manufacturing. Known additive manufacturing technologies are based on computer-controlled layer-by-layer building of the parts.

Technology challenges for Direct 3D printing include (1) preparation of ink-based printing materials necessary for realizing the desired properties for the 3D components, devices and objects; (2) deposition and process of the ink-based materials for 3D components, devices and objects, and (3) the complexity of computer aided design software control to produce a functional 3D device, such as an electronic device. The present disclosure provides a direct answer to these key technology challenges.

3D printing is primarily focused on single material manufacturing, such as plastics, polymers, metals, and even concrete. However,

For example, materials with electronic properties beyond insulation and conduction has so far eluded the 3D printing industry. The notion of creating 3D printable materials that have electronic properties has long been a goal for research and development. To print functional electronic devices, it is necessary to print at least six material types simultaneously, namely insulating, conducting, resistive, capacitive, n-type semiconducting, and p-type semiconducting materials. Thus, there is a need for improved systems for printing multi-material objects, components and devices, whether used for, for example, structural, ornamental, or electronic applications.

Additionally, there is a need for improved systems for printing multi-colored objects, components and devices. Embodiments of the three-dimensional printer system described herein are capable of printing objects using differently colored materials, resulting in a multi-colored object. This represents an improvement over known systems and methods which produce only single-colored products, or in which a multi-colored product may only be obtained by starting and stopping the printing process, changing materials between printing steps.

The present inventors have discovered certain capabilities of multi-material printing and have developed a system which is capable of superior print precision and accuracy using a plurality of materials and which demonstrates increased ease of use.

3D printing an electronic device with an FDM (fused deposition modeling) printer that exhibits the appropriate characteristics requires a mixture that remains sufficiently mechanically flexible to be consistently fed into the printer, while also containing enough of the active material to ensure the required electrical response. Additionally, the melting point of the mixture (i.e., filament) must remain within the operational range of the printing device. This calls for a balancing of properties in the mixture formula. Adding too much powder to increase electronic characteristics, may result in a filament that either is too brittle to print or the melting point is too high and may not allow for smooth printing. Conversely, a flexible filament that is easily printable may not possess the electronic properties needed.

Moreover, there is an ongoing need to reduce overall cost and waste. Use of a system as described herein allows for more precise administration of filament compositions without a need to interrupt the printing process to change out printing materials.

### SUMMARY

An exemplary three-dimensional printer is disclosed.

In an aspect, embodiments of a three-dimensional printer system are described herein, the system comprising (a) a housing having front portion and a rear portion; (b) a platform for supporting printed objects; (c) a filament cartridge station housed in an inner portion of the printer; (d) a printer arm configured to select a filament cartridge; (e) an area for a plurality of filament rolls, the area being accessible via the rear portion of the housing; and (f) a door on the front portion of the housing.

### BRIEF DESCRIPTION OF THE DRAWINGS

Other objects and advantages of the present disclosure will become apparent to those skilled in the art upon reading the following detailed description of exemplary embodiments, in conjunction with the accompanying drawings, in which like reference numerals have been used to designate like elements. Embodiments of the present invention are not limited to the embodiments described below or depicted in the drawings

FIG. 1 depicts a view of an exemplary, non-limiting embodiment of the three-dimensional printer.

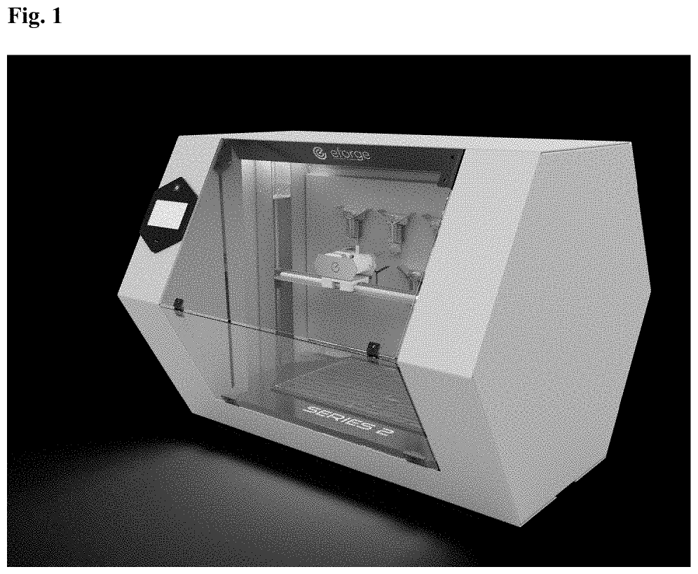

FIG. 2 depicts a view of an exemplary, non-limiting embodiment of the three-dimensional printer in which an access door or panel is in an open position and in which a multi-material, multi-colored object has been produced. The access door or panel is open, permitting removal or inspection of the printed object.

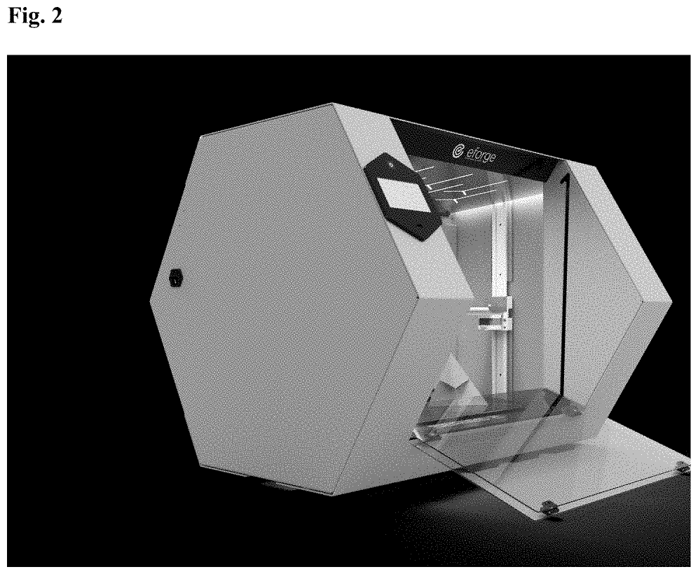

FIG. 3 depicts a second view of an exemplary, non-limiting embodiment of the three-dimensional printer in which an access door or panel is in an open position and in which a multi-material, multi-colored object has been produced. The access door or panel is open, permitting removal or inspection of the printed object.

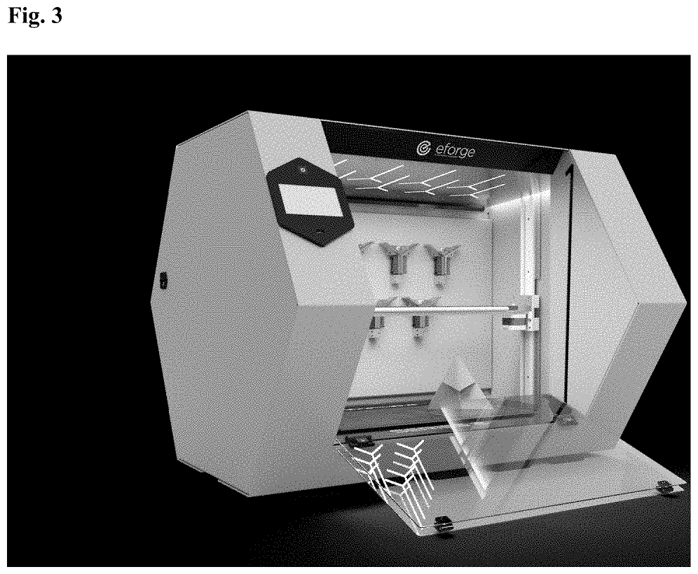

FIG. 4 depicts a straight-on view of an exemplary, non-limiting embodiment of the three-dimensional printer in which a multi-material, multi-colored object has been produced with the access door or panel in a closed position.

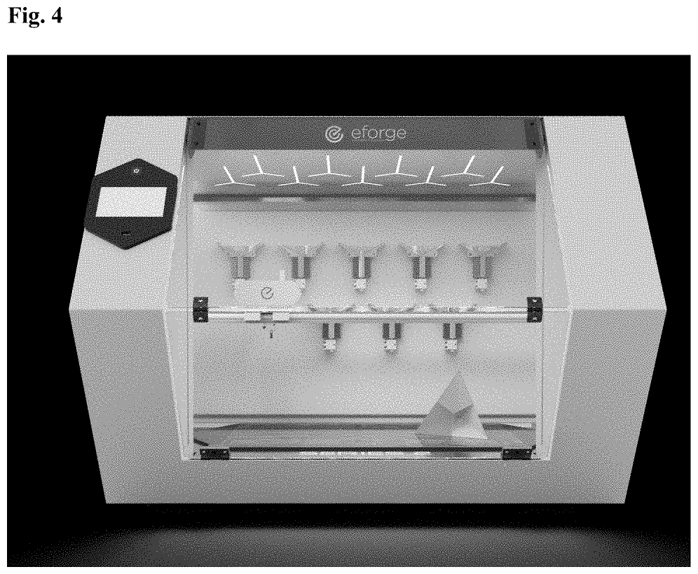

FIG. 5 depicts rear section of a non-limiting embodiment of the three-dimensional printer, showing room for up to eight filament rolls fed through a rear opening to the filament cartridge station.

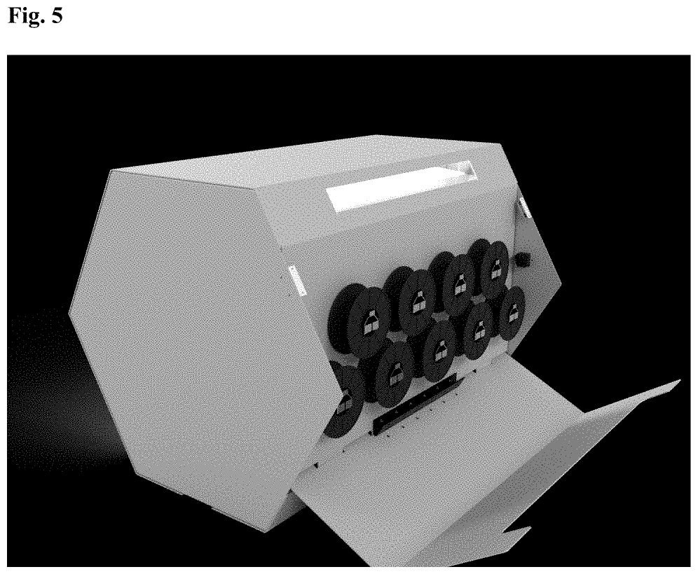

FIG. 6 depicts individual filament material cartridges affixed to the cartridge station.

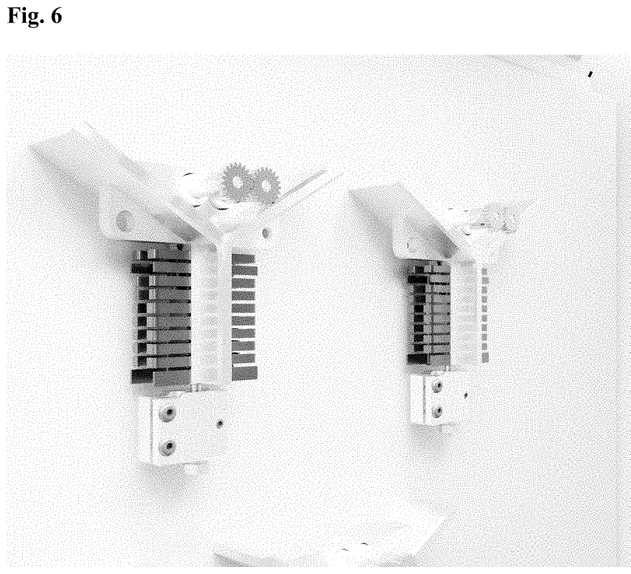

FIG. 7 depicts an embodiment of the three-dimensional printer having an eight-element station which holds individual filament cartridges for use by the print arm.

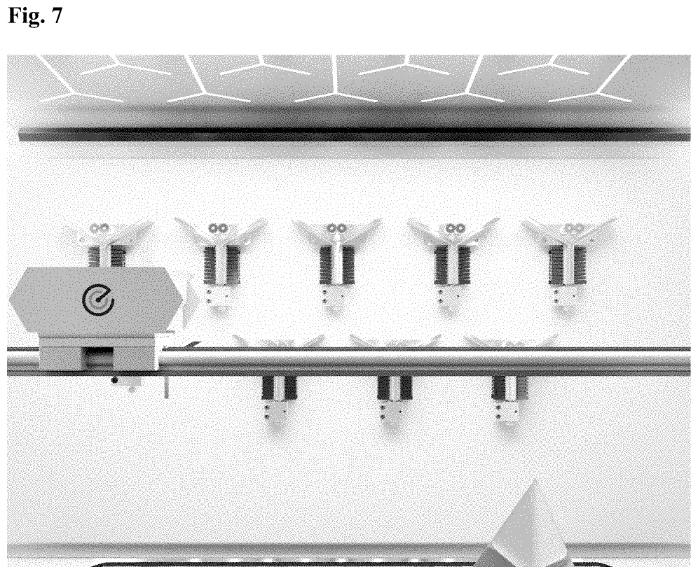

FIG. 8 depicts the filament print arm with a cartridge selected from the cartridge station.

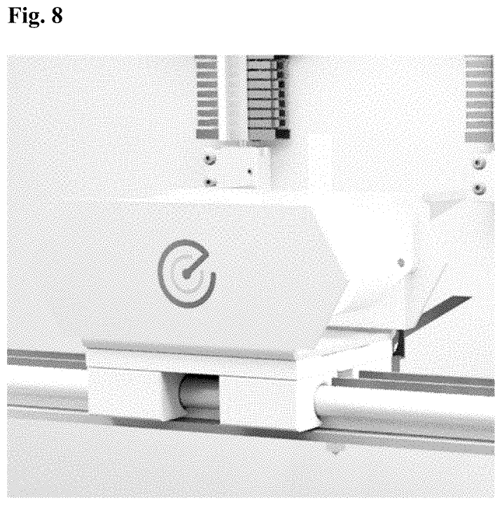

FIG. 9 depicts material filament rolls for use in the three-dimensional printer.

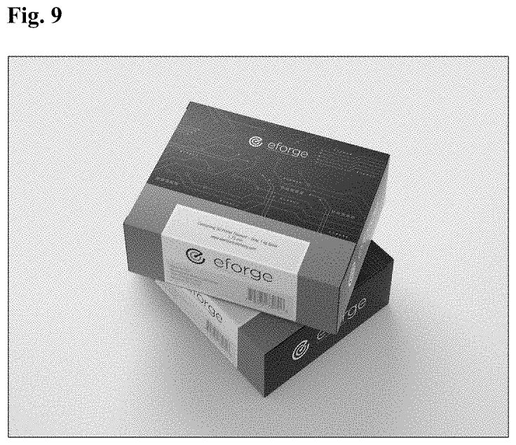

### DETAILED DESCRIPTION

A non-limiting, exemplary assembly for a multi-material three-dimensional printer is disclosed.

The three-dimensional printer includes a housing; a platform for supporting a component being processed within the housing; a print arm; an extruder assembly provided on the print arm, the extruder assembly configured to move horizontally in the housing to process the component on the supporting platform; a rail or other structure along which the extruder assembly moves horizontally, the rail or other structure being configured in some embodiments to move vertically to process the component on the supporting platform; a rear section which houses a plurality of interchangeable or replaceable filament rolls; a filament cartridge station configured to accommodate a plurality of elements, each element being configured to have a filament material cartridge affixed thereto.

In an aspect, filament rolls which may be of the same or different material are loaded into the three-dimensional printer in a rear section of the printer. The filament of a filament roll is fed to a filament cartridge station through a rear panel or portion of the printer.

In certain embodiments, the housing of the printer may include a user interface with one or more inputs, such as buttons, and/or a touch screen. The user interface may optionally include one or more means of connectivity to external media, such as USB flash drives, external hard drives, computers, tablets, and the like.

In certain embodiments, the platform for supporting a component being processed is configured to move vertically within the housing for processing the component.

An exemplary method for processing a component in a three-dimensional printer is disclosed. The three-dimensional printer having a movable platform and a movable extruder assembly arranged in a housing. The method comprising: receiving, in a processing device of the three-dimensional printer, one or more sensor measurements from the movable extruder assembly during printing of a component; controlling, via the processing device, a property of one or more extruders of the extruder assembly based on the one or more sensor measurements; adjusting, via the processing device, a position of at least one of the movable platform and the movable extruder assembly based on printing instructions received from a memory device.

In certain embodiments, an extruder assembly is provided which includes a carriage having one or more apertures and one or more extruders. In an aspect, each extruder may be attached to the carriage via at least one of the one or more apertures. The carriage is configured to be adaptable or otherwise compatible with the printer arm.

In certain embodiments, a fan assembly is provided which is configured to induce air flow around the plurality of extruders. In certain embodiments, optimized cooling fans of the extruder assembly and precision nozzle openings allow the filaments to exit through friction controlled systems for quality print every time.

In certain embodiments, the plurality of extruders can be independently controlled via a processing device. Each extruder may be configured to be retractable within the carriage via a respective aperture.

According to a non-limiting, exemplary embodiment, the extruders may be configured to be smart devices having automatic speed and oscillation controls to reduce material contamination.

What is claimed:

1. A three-dimensional printer system, the system comprising:
(a) a housing having front portion and a rear portion;
(b) a platform for supporting printed objects;
(c) a filament cartridge station housed in an inner portion of the printer;
(d) a printer arm configured to select a filament cartridge;
(e) an area for a plurality of filament rolls, the area being accessible via the rear portion of the housing; and
a door on the front portion of the housing.

2. The system of claim 1, wherein the printer arm includes an extruder assembly.

3. The system of claim 2, wherein the extruder assembly configured to move horizontally in the housing to process the component on the supporting platform.

4. The system of claim 2, wherein the extruder assembly is mounted on a rail for moving horizontally in the housing.

5. The system of claim 4, wherein the rail is configured to move vertically in the housing for the extruder assembly to process the component on the supporting platform.

6. The system of claim 4, comprising:
a user interface arranged on the housing.

7. The system of claim 6, wherein the user interface is configured to receive a user input.

8. The system of claim 2, comprising:
one or more sensors mounted to the extruder assembly.

9. The system of claim 1, comprising:
an extruder assembly mounted to the printer arm.

10. The system of claim 9, comprising:
a processor configured to receive measurements from the one or more sensors, and control at least one property of the extruder assembly based on the received measurements.

11. The system of claim 10, wherein the extruder assembly includes one or more extruders, and wherein the at least one property of the extruder assembly is associated with the one or more extruders.

12. The system of claim 9, wherein the carriage includes one or more apertures and the extruder assembly includes one or more extruders.

13. The system of claim 12, wherein each extruder is attached to the carriage via an associated aperture.

14. The system of claim 1, comprising:
a fan assembly configured to induce air flow around the extruder assembly.

15. The system of claim 14, wherein the fan assembly includes one or more cooling fans.

16. The system of claim 12, wherein the one or more extruders are configured to be retractable within the carriage via a respective aperture.

17. The system of claim 12, wherein the one or more extruders are configured as smart devices.

18. The system of claim 17, wherein the one or more extruders include automatic speed and oscillation controls that are configurable by the processor
